(19) United States
(12) Patent Application Publication
(10) Pub. No.: US 2019/0345968 A1
(43) Pub. Date: Nov. 14, 2019

(54) CLIP

(71) Applicant: D-ansermed Limited, Newton Abbot (GB)

(72) Inventor: Barry Guilfoyle, Newton Abbot (GB)

(73) Assignee: D-ansermed Limited, Newton Abbot (GB)

(21) Appl. No.: 16/409,806

(22) Filed: May 11, 2019

(30) Foreign Application Priority Data
May 14, 2018 (GB) GB1807791.7

(51) Int. Cl. F16B 21/09; A61G 7/10

(52) U.S. Cl. CPC F16B 21/09; A61G 7/1078

(57) ABSTRACT

A clip (101) for use with a hoist comprising a stud (401) having a shaft and a head. The clip (101) comprises a body (102), an aperture (106) provided in the body (102), and engaging means (109) connected to the body (102) and operable to move from an extended position to a retracted position as the shaft of the stud (401) is moved within the aperture (106) from one to the other of a first portion (107) configured to allow passage of the head of the stud of the hoist therethrough and a second portion (108) configured to prevent passage of the head of the stud of the hoist therethrough. The engaging means (109) is resiliently biased towards the extended position and is moved from an unstressed condition to a stressed condition when moved from the extended position to the retracted position. Hoist apparatus comprising the clip (101).

### FIELD OF THE INVENTION

The present invention relates to a clip, in particular to a clip for use with a hoist, and more particularly to a clip for use with a stud fixing spreader bar of a patient hoist.

### BACKGROUND OF THE INVENTION

A type of known hoist for lifting or supporting a patient comprises a support frame and a sling that attaches to the support frame. Typically, the sling is secured to the support frame by means of a clip that is configured to be releasably coupled with a headed stud provided on the support frame.

UK Patent No. GB 2513369 B discloses a clip for use with a hoist, the clip comprising a body, a keyhole aperture provided in the body, retaining means provided within a recess of the body and resilient biasing means provided with the recess of the body and operable to bias the retaining means towards an extended position. The keyhole aperture comprises a first portion and a second portion, which are shaped such that in use the head of a stud can pass through the first portion but cannot pass through the second portion. The retaining means comprises a pin having a first end in engagement with the resilient biasing means and a second free extends that extends into the second portion of the keyhole aperture when in the first extended position.

It is desirable to provide an improved clip for use with a hoist, in particular to provide a clip for a hoist that has a superior design for manufacture.

### SUMMARY OF THE INVENTION

According to a first aspect there is provided a clip for use with a hoist comprising a stud having a shaft and a head, the clip comprising: a body; an aperture provided in the body, the aperture comprising a first portion and a second portion, the first portion of the aperture configured to allow passage of the head of the stud of the hoist therethrough, and the second portion of the aperture configured to prevent passage of the head of the stud of the hoist therethrough; the clip further comprising engaging means, the engaging means connected to the body and operable to move from an extended position to a retracted position, the engaging means resiliently biased towards the extended position; and the engaging means movable from the extended position to the retracted position as the shaft of the stud of the hoist is moved from one of the first portion and the second portion of the aperture to the other of the first portion and the second portion of the aperture in contact with the engaging means; wherein the engaging means is moved from an unstressed condition to a stressed condition as the engaging means is moved from the extended position to the retracted position; and wherein the engaging means comprises a deflectable arm, the deflectable arm having a fixed end and a free end.

In an example, the engaging means comprises a single deflectable arm. The free end of the deflectable arm may comprise a contact portion for contacting the shaft of the stud of the hoist. The free end of the deflectable arm may comprise a contact portion for contacting the shaft of the stud of the hoist, the contact portion of the deflectable arm shaped such that the stud of the hoist is movable from the first portion to the second portion of the aperture more easily than it is movable from the second portion to the first portion of the aperture.

In an example, the engaging means comprises a pair of deflectable arms, each deflectable arm having a fixed end and a free end. The free end of each the pair of deflectable arms may comprise a contact portion for contacting the shaft of the stud of the hoist. The free end of each the pair of deflectable arms may comprise a contact portion for contacting the shaft of the stud of the hoist, the contact portion of each of the pair of deflectable arms shaped such that the stud of the hoist is movable from the first portion to the second portion of the aperture more easily than it is movable from the second portion to the first portion of the aperture.

The clip may be a unitary component. The clip may comprise a plastics material.

The clip may comprise a connection aperture for use in attaching the clip to a hoist sling.

According to a second aspect there is provided a hoist apparatus, comprising: a support frame comprising at least one headed stud; a hoist sling; and a clip according to the first aspect for detachably coupling the hoist sling to a headed stud of the support frame.

Further particular and preferred aspects of the present invention are set out in the dependent claims.

### BRIEF DESCRIPTION OF THE DRAWINGS

The present invention will now be more particularly described, with reference to the accompanying drawings, in which:

FIG. 1 shows a plan view of a first face of a clip;

FIG. 2 shows a plan view of a second face of the clip of FIG. 1;

FIG. 3 shows a perspective view of the clip of FIGS. 1 and 2;

FIGS. 4 to 6 show steps in coupling the clip of FIGS. 1 to 3 to a stud of a hoist;

FIGS. 7 to 9 show steps in uncoupling the clip of FIGS. 1 to 3 from a stud of a hoist; and

FIG. 10 shows another clip.

### DESCRIPTION

Example embodiments are described below in sufficient detail to enable those of ordinary skill in the art to embody and implement the apparatus, systems and processes described herein. It is to be understood that embodiments can be provided in many alternate forms and the invention should not be construed as limited to the specific embodiments and examples set forth herein but by the scope of the appended claims.

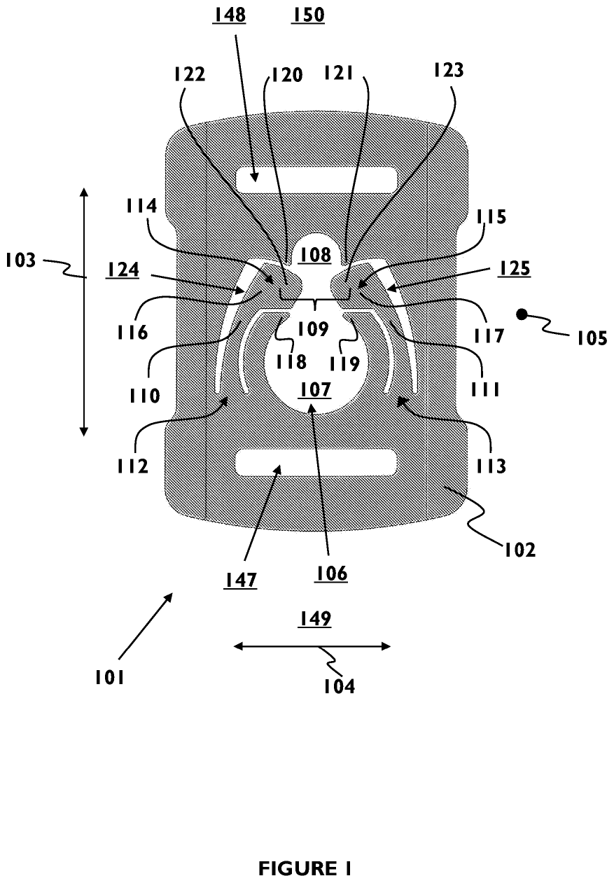

A clip 101 is shown in FIGS. 1 to 3. The clip 101 is usable with a hoist (not shown) comprising a stud having a shaft and a head (not shown), the hoist for lifting or supporting a patient.

Clip 101 comprises a body 102. The body has a length direction 103, a width direction 104, and a depth direction 105.

An aperture 106 is provided in the body 102. The aperture 106 is configured to receive the stud of the hoist. The aperture 106 comprises a first portion 107 and a second portion 108. The first portion 107 of the aperture 106 is configured to allow passage of the head of the stud of the hoist therethrough, in the depth direction 105, and the second portion 108 of the aperture 106 is configured to prevent passage of the head of the stud of the hoist therethrough, in the depth direction 105.

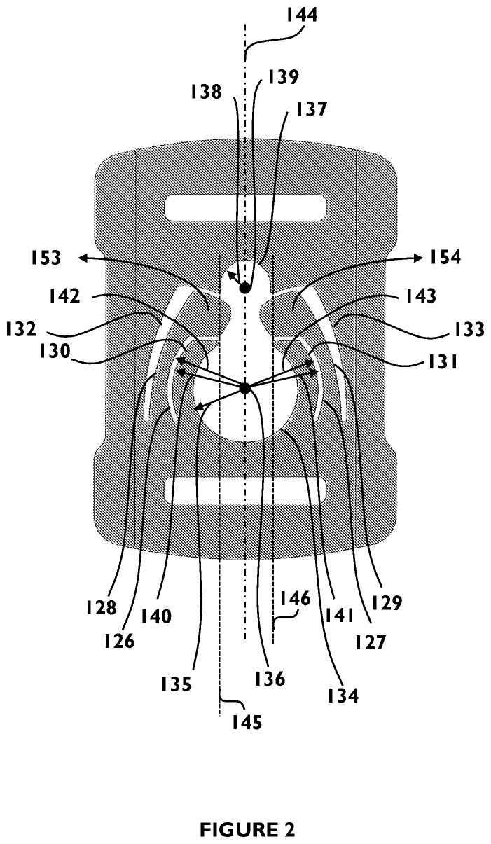

Clip 101 further comprises engaging means 109. The engaging means 109 is connected to the body 102. The engaging means 109 is operable to move from an extended position (shown in FIGS. 1 and 2) to a retracted position. The engaging means 109 is resiliently biased towards the extended position.

The engaging means 109 is movable from the extended position to the retracted position as the shaft of the stud of the hoist is moved from one of the first portion 107 and the second portion 108 of the aperture 106 to the other of the first portion 107 and the second portion 108 of the aperture 106, when in contact with the engaging means 109. The engaging means 109 is moved from an unstressed condition to a stressed condition as the engaging means 109 is moved from the extended position to the retracted position.

The engaging means 109 is movable from the extended position to the retracted position as the shaft of the stud of the hoist is moved from the first portion 107 to the second portion 108 of the aperture 106 and also as the shaft of the stud of the hoist is moved from the second portion 108 to the first portion 107 of the aperture 106.

More specifically, the engaging means 109 is movable from the extended position to the retracted position and back to the extended position as the shaft of the stud of the hoist is moved from the first portion 107 to the second portion 108 of the aperture 106 and also as the shaft of the stud of the hoist is moved from the second portion 108 to the first portion 107 of the aperture 106.

When the shaft of the stud of the hoist has been moved from the first portion 107 into the second portion 108, the stud is maintained in the second portion 108 by the head of the stud preventing the stud from being withdrawn from the second portion 108 in the depth direction 105 of the clip 101 and by the engaging means 109 preventing the shaft of the stud from travelling back into the first portion 107 without being deliberately moved.

In an embodiment, the clip 101 is a unitary component. In an embodiment, the clip 101 is fabricated from a single material. In an embodiment, the clip 101 comprises a plastics material. In an example, the plastics material is polyoxymethylene (POM), also known as acetal.

According to the present embodiment, the engaging means 109 comprises a pair of deflectable arms 110, 111, each arm 110, 111 having a fixed end 112, 113 and a free end 114, 115. With this arrangement, the free end 114, 115 of each deflectable arm 110, 111 is movable with respect to the respective fixed end 112, 113.

The free end 114, 115 of each the pair of arms 110, 111 comprises a contact portion 116, 117 for contacting the shaft of the stud of the hoist when the clip 101 is being coupled thereto.

According to the shown arrangement, the aperture 106 defines a pair of first portion corners 118, 119 and a pair of second portion corners 120, 121 that are displaced from the pair of first portion corners 118, 119 in the length direction 103 of the clip 101, and the engaging means 109 defines a pair of contact portion corners 122, 123 disposed between the pair of first portion corners 118, 119 and the pair of second portion corners 120, 121 in the length direction 103 of the clip 101.

The deflectable arms 110, 111 are located within respective recesses 124, 125. Each of the arms 110, 111 has an inner edge 126, 127 and an outer edge 128, 129. Each of the recesses 124, 125 has an inner edge 130, 131 and an outer edge 132, 133. The first portion 107 of the aperture 106 is defined by an inner edge 134.

In this example, the inner edge 134 of the first portion 107 defines an incomplete circle having a radius 135 from point 136.

The second portion 108 of the aperture 106 is defined by an inner edge 137. In this example, the inner edge 137 of the second portion 108 defines an incomplete circle having a radius 138 from point 139.

The radius 138 of the second portion 108 of the aperture 106 is smaller than the radius 135 of the first portion 107 of the aperture 106.

In an example, the radius 135 of the first portion 107 of the aperture 106 is in the range 5 mm and 25 mm, and the radius 138 of the second portion 108 of the aperture 106 is in the range 2.5 mm to 12.5 mm.

In this example, the inner edge 130, 131 of each of the recesses 124, 125 comprises an arc having a radius 140, 141 from point 136, the radius 140, 141 of the arc of the inner edge 130, 131 of each of the recesses 124, 125 being greater than the radius 135 of the inner edge 134 of the first portion 107. In this example, the inner edge 126, 127 of each of the arms 110, 111 comprises an arc having a radius 142, 143 from point 136, the radius 142, 143 of the arc of the inner edge 126, 127 of each of the arms 110, 111 being greater than the radius 140, 141 of the arc of the inner edge 130, 131 of each of the recesses 124, 125. In this example, the outer edge 128, 129 of each of the arms 110, 111 comprises a curve. In this example, the outer edge 132, 133 of each of the recesses 124, 125 comprises a curve.

According to this illustrated embodiment, the clip 101 is symmetrical about a centreline 144 extending in the length direction 103.

The first portion corners 118, 119 and the second portion corners 120, 121 are aligned along a respective axis 145, 146 extending in the length direction 103 of the clip 101 substantially parallel to centreline 144. When the deflectable arms 110, 111 are in the extended position, the contact portion corners 122, 123 are disposed inwardly of the axes 145, 146, at a position between the respective axis 145, 146 and the centreline 144.

As shown, the clip 101 defines a first connection aperture 147. In addition, in this example, the clip 101 further defines a second connection aperture 148. The first connection aperture 147, which is located between the first portion 107 of the aperture 106 and the lower end 149 of the clip 101, is for use in attaching the clip 101 to a hoist sling. In this example, the first connection aperture 147 is configured to receive a webbing strap of a hoist sling. The second connection aperture 148, which is located between the first portion 107 of the aperture 106 and the upper end 150 of the clip 101 may be used to connect a grab handle (not shown) to the clip 101. A grab handle, which may be formed from a webbing strap, can facilitate removal of the clip 101 from a stud of a hoist.

Clip 101 is suitable for use in a hoist apparatus, the hoist apparatus comprising a support frame comprising at least one headed stud and a hoist sling, the clip 101 usable to detachable couple the hoist sling to a headed stud of the support frame.

The clip 101 can be coupled to the hoist sling by engaging a webbing strap thereof with the first connection aperture 147 and the clip 101 can be releasably engaged with a headed stud of the support frame.

The clip 101 is hygienic and has no external parts that can be damaged during washing or storage; the engaging means 109, and in particular the deflectable arms 110, 111 of the illustrated embodiment, are disposed within the body 102 of the clip 101. The engaging means 109 provides a safety feature, which beneficially functions to prevent the clip 101 from detachment whilst under load. In addition, the engaging means 109, and in particular the deflectable arms 110, 111 of the illustrated embodiment, can advantageously provide audible and/or tactile feedback that the clip 101 has been properly coupled to the headed stud of the support frame.

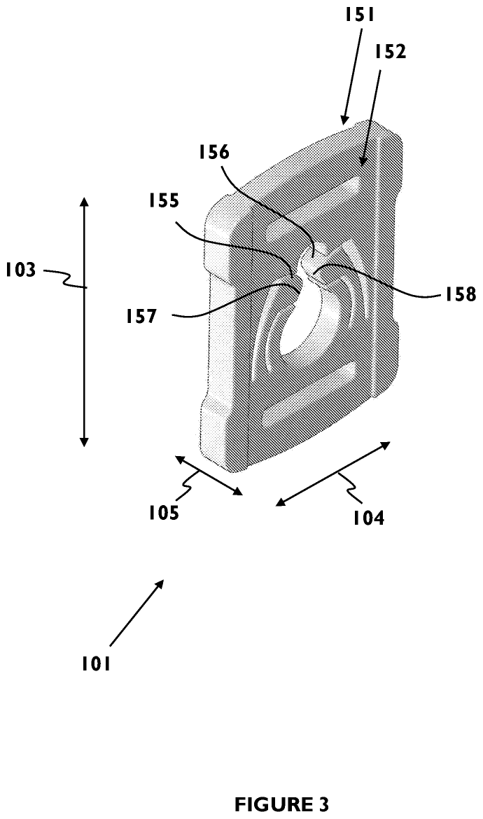

As can be seen in FIG. 3 in particular, according to this illustrated embodiment, each face of the clip 101 defines a recessed region 151, 152 which is dimensioned to accommodate at least the thickness of a webbing strap of a hoist sling.

The clip 101 is operable as follows. The headed stud of the hoist is inserted through the first portion 107 of the aperture 106 of the clip 101, in the depth direction 105, and is then slidably moved from the first portion 107 to the second portion 108, in the length direction 103. As the stud is moved from the first portion 107 to the second portion 108 of the aperture 106, the shaft of the stud contacts the engaging means 109 and causes the engaging means 109 to move from the extended position into the retracted position. According to this illustrated embodiment, the arms 110, 111 are shifted from the extended position to a retracted position by pivoting outwards, in the respective directions indicated by arrows 153, 154, about the respective fixed ends 112, 113. As the arms 110, 111 are pushed towards a retracted position from the extended position, the outer edge 128, 129 of each arm 110, 111 is placed in a state of compression and the inner edge 126, 127 of each arm 110, 111 is placed in a state of tension. The stress imparted into the arms 110, 111 as the stud pushes the arms 110, 111 into a retracted position acts to bias the arms 110, 111 towards the extended position. As the stud is moved through the gap between the deflectable arms 110, 111, the stud travels through a first phase in which the arms 110, 111 pivot outwardly from the extended position, to a position in which the arms 110, 111 have been rotated to a position of maximum deflection, which is determined by the size of the shaft of the stud, and then through a second phase in which the arms 110, 111 pivot inwardly towards the extended position, to return the arms 110, 111 from a stressed condition back into the unstressed condition.

Thus, the stress imparted into the engaging means 109 as the engaging means 109 move from the extended position to a retracted position as the shaft of the stud of the hoist is moved from one of the first portion 107 and the second portion 108 of the aperture 106 to the other of the first portion 107 and the second portion 108 of the aperture 106 in contact with the engaging means 109 acts to bias the engaging means 109 towards the extended position.

In the illustrated embodiment, the contact portion 116, 117 of each of the pair of arms 110, 111 is shaped such that the stud of the hoist is movable from the first portion 107 to the second portion 108 of the aperture 106 more easily than it is movable from the second portion 108 to the first portion 107 of the aperture 106. In this example, the contact portion 116, 117 of each of the arms 110, 111 comprises a first edge 155, 156 that extends from the respective contact portion corner 122, 123 towards the respective outer edge 128, 129 and a second edge 158, 159 that extends from the respective contact portion corner 122, 123 towards the respective inner edge 126, 127, the first edge 155, 156 and the second edge 157, 158 being shaped differently.

The aperture 106 and engaging means 109 are dimensioned to allow the clip 101 to be used with headed studs that have different sized shafts.

The outer edge 132, 133 of each of the recesses 124, 125 limits the extent that the respective arm 110, 111 can be deflected from the extended position.

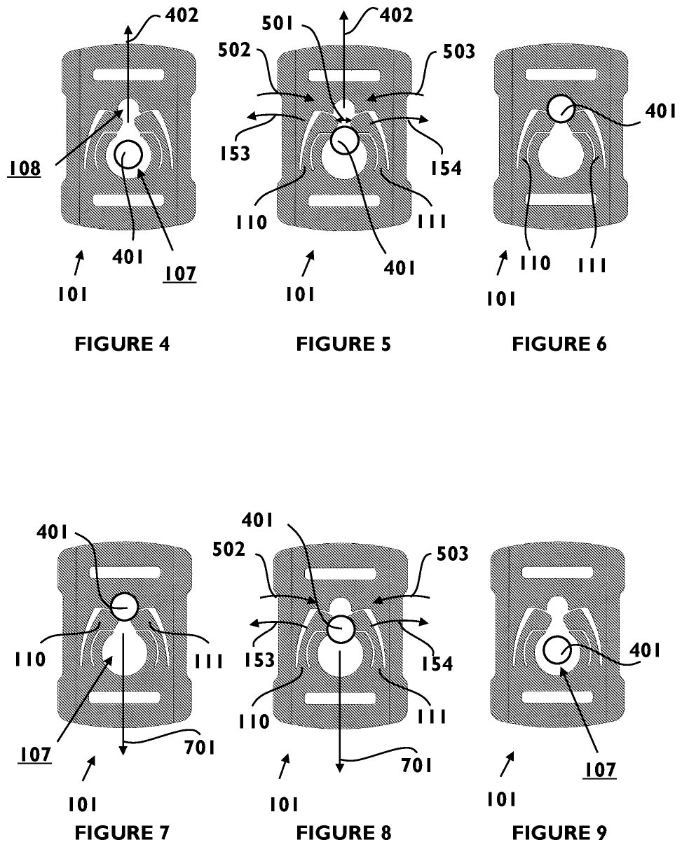

FIGS. 4 to 6 show stages in coupling clip 101 with a stud 401 of a support frame or a hoist apparatus. As illustrated in FIG. 4, the stud 401 is inserted through the clip 101, into the first portion 107 of the aperture 106. The stud 401 is then moved upwards, in the direction indicated by arrow 402, towards the second portion 108 of the aperture 106. As illustrated in FIG. 5, this action causes the stud 401 to enter the gap 501 between the deflectable arms 110, 111, which are in the extended position and in an unstressed condition. As the stud 401 is moved further upwards, the arms 110, 111 move outwards, in the respective directions indicated by arrows 153 and 154, into a retracted position and into a stressed condition. As illustrated in FIG. 6, as the stud 401 is moved even further upwards, the stud 401 enters the second portion 108 of the aperture 106 and the arms 110, 111 move inwards, in the respective directions indicated by arrows 502 and 503, back towards the extended position, under the stud 401. The stud 401 is secured in the second portion 108 of the aperture 106; the size of the head of the stud 401 relative to the size of second portion of the aperture 106 prevents the stud 401 from pulled through the clip 101 and the arms 110, 111 support the stud 401 in the raised position within the clip 101.

FIGS. 7 to 9 show stages in uncoupling clip 101 with stud 401. As illustrated in FIG. 7 the stud 401 is moved downwards, in the direction indicated by arrow 701, towards the first portion 107 of the aperture 106. As illustrated in FIG. 8, this action causes the stud 401 to enter the gap 501 between the deflectable arms 110, 111, which are in a retracted position and in a stressed condition. As the stud 401 is moved further downwards, the arms 110, 111 move outwards, in the respective directions indicated by arrows 153 and 154, into a retracted position and into a stressed condition. As illustrated in FIG. 9, as the stud 401 is moved even further downwards, the stud 401 enters the first portion 107 of the aperture 106 and the arms 110, 111 move inwards, in the respective directions indicated by arrows 502 and 503, towards the extended position, above the stud 401. The stud 401 can then be removed from the second portion 108 of the aperture 106.

Although reference is made to the stud 401 moving within the aperture 106 of the clip 101, it is to be appreciated that the clip 101 in use is moved relative to the stud 401.

Further, it is to be appreciated that the engaging means in another embodiment could be “less stressed” when in an extended position than when in a retracted position; with reference to such an embodiment, the terms “unstressed” and “stressed” as used herein are thus to be understood otherwise as relative and describing the different stress conditions of the engaging means when in the extended and retracted positions respectively.

The clip 101 is convenient and cost-effective to manufacture.

The engaging means 109 being inherently biased towards the extended position by the design and material of the clip 101 advantageously simplifies the construction and production of the clip 101.

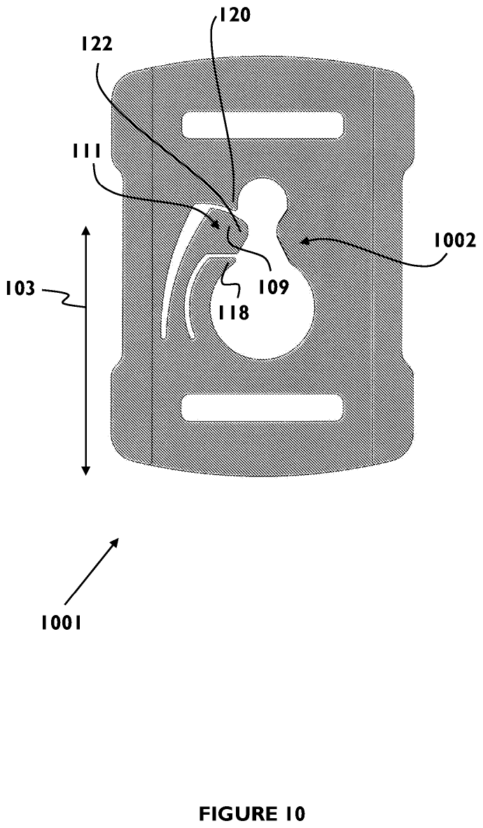

Another clip 1001 is shown in FIG. 10. Clip 1001 is a variant of clip 101, in which the engaging means 109 comprises only a single deflectable arm 110. According to the shown arrangement, the aperture 106 of clip 1001 defines a first portion corner 118 and a second portion corner 120 that is displaced from the first portion corner 118 in the length direction 103 of the clip 1001, and the engaging means 109 defines a contact portion corner 122 disposed between the first portion corner 118 and the second portion corner 120 in the length direction 103 of the clip 1001. In this example, the contact portion corner 122 of the engaging means 109 is at the free end of the deflectable arm 110. In this illustrated embodiment, the engaging means 109 does not comprise another deflectable element. In this illustrated embodiment, comparing clip 1001 to clip 101, clip 1001 comprises a non-deflectable portion 1002 in the region that the clip 101 comprises another deflectable arm 111.

The present invention thus provides a clip for use with a hoist comprising a stud having a shaft and a head. The present invention further provides a hoist apparatus, comprising a support frame comprising at least one headed stud, a hoist sling, and the clip, the clip for detachably coupling the hoist sling to a headed stud of the support frame.

Variations and modifications of the foregoing are within the scope of the present invention as defined by the appended claims. It is therefore to be appreciated that a clip according to the present invention may vary in respect of one or more features of an embodiment and/or example as described previously. For example, the engaging means may comprise only a single deflectable arm with another deflectable element.

1: A clip for use with a hoist comprising a stud having a shaft and a head, the clip comprising:
a body;
an aperture provided in the body, the aperture comprising a first portion and a second portion,
the first portion of the aperture configured to allow passage of the head of the stud of the hoist therethrough, and
the second portion of the aperture configured to prevent passage of the head of the stud of the hoist therethrough;
the clip further comprising engaging means, the engaging means connected to the body and operable to move from an extended position to a retracted position, the engaging means resiliently biased towards the extended position; and
the engaging means movable from the extended position to the retracted position as the shaft of the stud of the hoist is moved from one of the first portion and the second portion of the aperture to the other of the first portion and the second portion of the aperture in contact with the engaging means;
wherein the engaging means is moved from an unstressed condition to a stressed condition as the engaging means is moved from the extended position to the retracted position; and
wherein the engaging means comprises a deflectable arm, the deflectable arm having a fixed end and a free end.

2. A clip as claimed in claim 1, wherein the engaging means comprises a single deflectable arm.

3. A clip as claimed in claim 2, wherein the free end of the deflectable arm comprises a contact portion for contacting the shaft of the stud of the hoist.

4. A clip as claimed in claim 3, wherein the contact portion of the deflectable arm is shaped such that the stud of the hoist is movable from the first portion to the second portion of the aperture more easily than it is movable from the second portion to the first portion of the aperture.

7. A clip as claimed in claim 2, wherein the clip has a length direction, the aperture defines a first portion corner and a second portion corner that is displaced from the first portion corner in the length direction, and the engaging means defines a contact portion corner disposed between the first portion corner and the second portion corner in the length direction.

8. A clip as claimed in claim 1, wherein the engaging means comprises a pair of deflectable arms, each deflectable arm having a fixed end and a free end.

9. A clip as claimed in claim 8, wherein the free end of each the pair of deflectable arms comprises a contact portion for contacting the shaft of the stud of the hoist.

10. A clip as claimed in claim 9, wherein the contact portion of each of the pair of deflectable arms is shaped such that the stud of the hoist is movable from the first portion to the second portion of the aperture more easily than it is movable from the second portion to the first portion of the aperture.

11. A clip as claimed in claim 8, wherein the clip has a length direction, the aperture defines a pair of first portion corners and a pair of second portion corners that are displaced from the pair of first portion corners in the length direction, and the engaging means defines a pair of contact portion corners disposed between the pair of first portion corners and the pair of second portion corners in the length direction.

12. A clip as claimed in claim 1, wherein the clip is a unitary component.

13. A clip as claimed in claim 12, wherein the clip comprises a plastics material.

14. A clip as claimed in claim 13, wherein the plastics material is polyoxymethylene (POM).

15. A clip as claimed in claim 1, wherein the clip comprises a connection aperture for use in attaching the clip to a hoist sling.

16. A clip as claimed in claim 8, wherein the clip comprises a connection aperture for use in attaching the clip to a hoist sling.

17. A hoist apparatus, comprising:
a support frame comprising at least one headed stud;
a hoist sling; and
a clip according to claim 1 for detachably coupling the hoist sling to a headed stud of the support frame.

18. A hoist apparatus, comprising:
a support frame comprising at least one headed stud;
a hoist sling; and
a clip according to claim 8 for detachably coupling the hoist sling to a headed stud of the support frame.
